(19) United States
(12) Patent Application Publication
(10) Pub. No.: US 2006/0136342 A1
(43) Pub. Date: Jun. 22, 2006

(54) Content protection method, and information recording and reproduction apparatus using same

(75) Inventors: Yoshimitsu Nakamura, Nara (JP); Kiyoshi Tominaga, Osaka (JP)

Correspondence Address: BACON & THOMAS, PLLC, 625 SLATERS LANE, FOURTH FLOOR, ALEXANDRIA, VA, 22314, US

(73) Assignee: Matsushita Electric Industrial Co., Ltd., Osaka (JP)

(21) Appl. No.: 11/272,671

(22) Filed: Nov. 15, 2005

(30) Foreign Application Priority Data
Dec. 16, 2004 (JP) 2004-363871

(51) Int. Cl. G06Q 99/00

(52) U.S. Cl. 705/57

(57) ABSTRACT

In content protection method and apparatus, a title key invalidation information is generated for invalidating a title key corresponding to a content in a medium and a content key is generated from the title key and the title key invalidation information. The content is encrypted based on the content key. The title key invalidation information is changed in case of removing or moving the content from the medium and the changed title key invalidation information is stored in the medium. Therefore, the content is prevented from being replicated while enabling the content to be reproduced in another medium.

### FIELD OF THE INVENTION

The present invention relates to a content protection method for copyright protection and recording of various digital contents, e.g. video and audio data, on recordable media, and an information recording and reproduction apparatus using same.

### BACKGROUND OF THE INVENTION

In a rewritable optical disk such as DVD-RAM or DVD-RW, the copyright of a content recorded in the disk is protected by using a title key assigned to a title, a unique media ID assigned to every disk, device keys assigned to a drive and a reproduction device, and a media key block(MKB) serving as device key invalidation information, which is placed in an overwriting disabled (lead-in) area provided outside a user area(or a user data area) of the disk.

In this scheme, the device key which is key-processed by the MKB, the media ID and the title key are used to encrypt the content. Accordingly, even when the encrypted content is illegally copied onto another disk, the content's copyright is protected since the other disk will not have the same media ID and therefore the encrypted content cannot be decrypted. (See, e.g., “Content Protection for Recordable Media Specification DVD Book”, <URL://www.4Centity.com/>)

However, allowing a move of content in the prior art scheme would raise an issue against the copyright protection. That is, as shown in FIG. 8, by copying contents of original disk 201 onto provisional copy disk 202 (step 1), moving content B from original disk 201 to destination hard disk 204 (step 2) and then copying the content B from provisional copy disk 202 back onto original disk 201 to thereby return the copied data to original disk 201 as it was (step 3), the content B is restored and can be reproduced. Because the contents can be replicated endlessly by repeating the above content move and copying processes, it is not permitted in the prior art to move contents between disks or to another medium e.g. a hard disk. Accordingly, such editing of contents as collecting the contents from a plurality of disks into a single disk has not been possible.

Further, in the prior art, it is possible to copy to another area of the original disk, although copying to another disk is impossible. That is, a plurality of identical contents can exist in one disk and it is possible to edit them separately. Such is not desirable in terms of copyright protection.

### SUMMARY OF THE INVENTION

It is, therefore, an object of the present invention to provide a content protection method and an information recording and reproduction apparatus allowing move and copying of contents.

In accordance with a preferred embodiment of content protection scheme of the present invention, an encrypted title key invalidation information is placed in an area outside a user area of a medium(e.g. a disk) and a content key for use in decrypting an encrypted content is obtained by a key-operation on a title key and the title key invalidation information. When moving a content, the title key invalidation information of the original medium is changed, to thereby invalidating a corresponding title key. Accordingly, it is impossible to decrypt the encrypted content in the original medium after moving content, and therefore, replication of contents is prevented.

Further, a modified content key is generated by using the content key and a block address of the content, so that differently modified content keys are assigned to different blocks. Therefore, when copying a content into another area within same medium, the copied content cannot be reproduced since the modified content key is different. As a result, replication of contents within a medium can be prevented.

Further, in accordance with another embodiment of the present invention, an encrypted status key is stored in an area outside a user area of a medium and a title key invalidation information encrypted by the status key is stored in the user area. When moving a content, the title key invalidation information of the original medium is changed and then, the changed title key invalidation information is encrypted by using a new status key. As a result, after moving the content, replication of the content and the title key invalidation information existing in the user area can be prevented.

Therefore, in accordance with the present invention, replication of content is prevented while allowing a content to be moved between disks or to another medium, e.g. a hard disk.

Further, illegal replication within an identical medium can be also prevented.

Further, without restricting the data size of the title key invalidation information by a writable capacity of the area outside the user area of medium, same effects such as prevention of replication can be obtained.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of a system in accordance with a first preferred embodiment of the present invention;

FIG. 2 sets forth a block diagram of a system in accordance with a second preferred embodiment of the present invention;

FIG. 3 presents a schematic flow diagram of an authentication procedure in accordance with the first and the second preferred embodiment of the present invention;

FIG. 4 shows a schematic flow diagram of a structure and a processing sequence of the first preferred embodiment of the present invention;

FIG. 5 describes a schematic flow diagram of a structure and a processing sequence of the second preferred embodiment of the present invention;

FIG. 6 illustrates a schematic flow diagram of a structure and a processing sequence of a third preferred embodiment of the present invention;

FIG. 7 is a schematic flow diagram of a structure and a processing diagram for a status key update in accordance with the preferred embodiment of the present invention; and

FIG. 8 is a schematic drawing for explaining problems of the prior art.

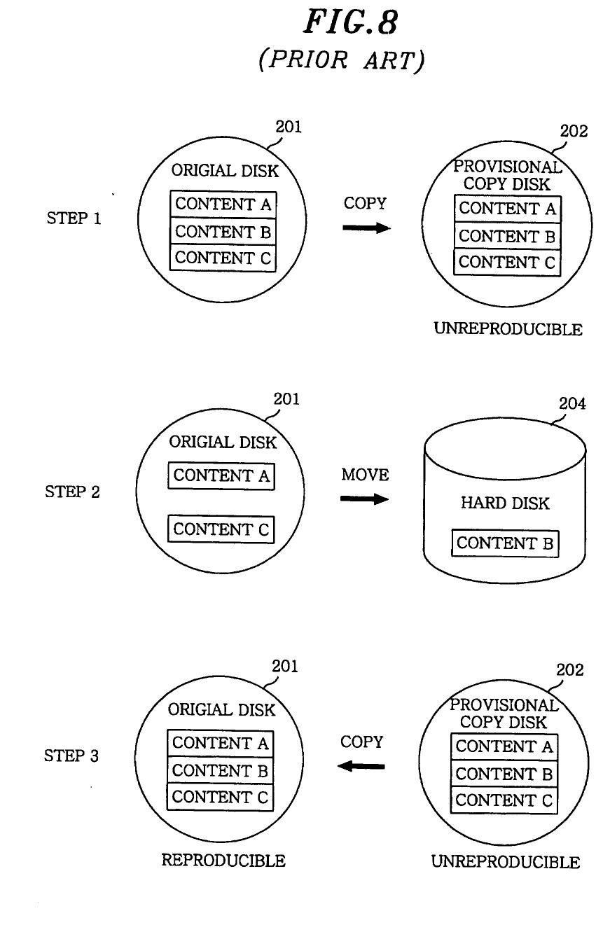

### DETAILED DESCRIPTION OF THE PREFERRED EMBODIMENTS

The present invention relates to a copyright protection method for preventing those who do not have a right for use digital content data, e.g. video and audio data, from illegally replicating the digital content data when the digital content data is stored on an information record medium, e.g. a memory card or an optical disk.

It is preferable that the present invention is executed in combination with the CPRM(Content Protection for Recordable Media) of the prior art reference described above. Hereinafter, preferred embodiments of the present invention will be discussed with reference to the drawings.

### First Preferred Embodiment

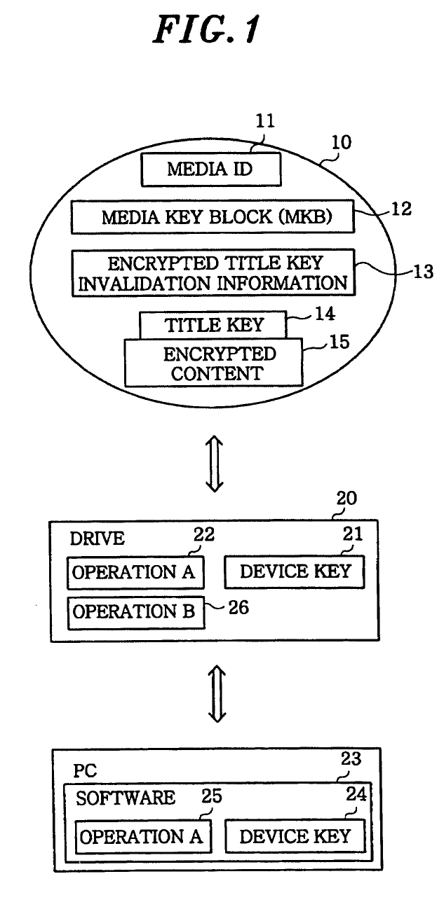

With reference to FIG. 1, media ID 11 uniquely assigned to every medium and media key block(MKB) 12 serving as device key invalidation information are written in advance in an area outside the user area as overwriting disabled information. Encrypted title key invalidation information 13 is stored in a writable area outside the user area and title key 14 corresponding to stored content 15 is stored as content management information. Content 15 is stored after being encrypted by a key generated by exclusive-OR operation on a content key and a block address. Drive 20 driving the medium therein has device key 21 and a content reproduction device, e.g. software 23 executing content reproduction and editing in a personal computer(PC), also has device key 24.

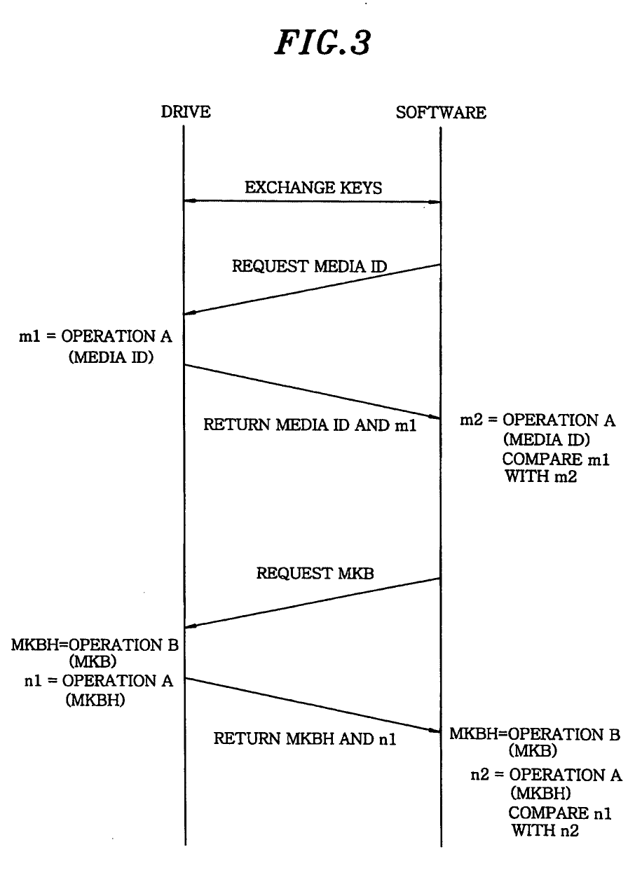

First, software 23 and drive 20 performs authentication by exchanging keys. As described in the processing sequence illustrated in the schematic flow diagram of FIG. 3, the authentication further proceeds by reading the media ID from medium 10 by drive 20 and comparing by software 23 results calculated by operation A blocks 22 and 25 performing secret authentication operations A by using the exchanged keys and the media ID as operation parameters. Next, MKBH is calculated by operation B in order to validate MKB. Operation A blocks 22 and 25 also operate on the MKBH, and the results are compared each other. If the results are identical to each other, the drive and the software are regarded as being authenticated, and next processes can be carried out.

Specifically, authentication is required first by exchanging or sharing keys between software 23 and drive 20. As briefly described in FIG. 3, the authentication is performed by exchanging keys in software 23 and drive 20. If the authentication is successful, software 23 requests the media ID from drive 20. Drive 20 in receipt of the media ID request from software 23 reads the media ID from medium 10, performs secret operation A on the exchanged key and the media ID in operation A block 22 and then sends the operation result m1 and the media ID to software 23. Next, software 23 performs operation A on the received media ID and the exchanged key in operation A block 25 and compares the operation result m2 with the result m1 from operation A block 22 of drive 20. If the results m1 and m2 are identical, software 23 requests MKB from drive 20 to validate MKB. Drive 20 in receipt of the MKB request from software 23 computes MKBH by performing operation B on MKB in operation B block 26. And then, drive 20 performs operation A on the MKBH in operation A block 22 to obtain an operation result n1 and sends the result n1, and the MKBH to software 23. Next, software 23 performs operation A on the received MKBH in operation A block 25 to obtain an operation result n2 and compares the result n2 with the result n1 from drive 20 to check whether they are identical. If they are identical, a subsequent process can proceed.

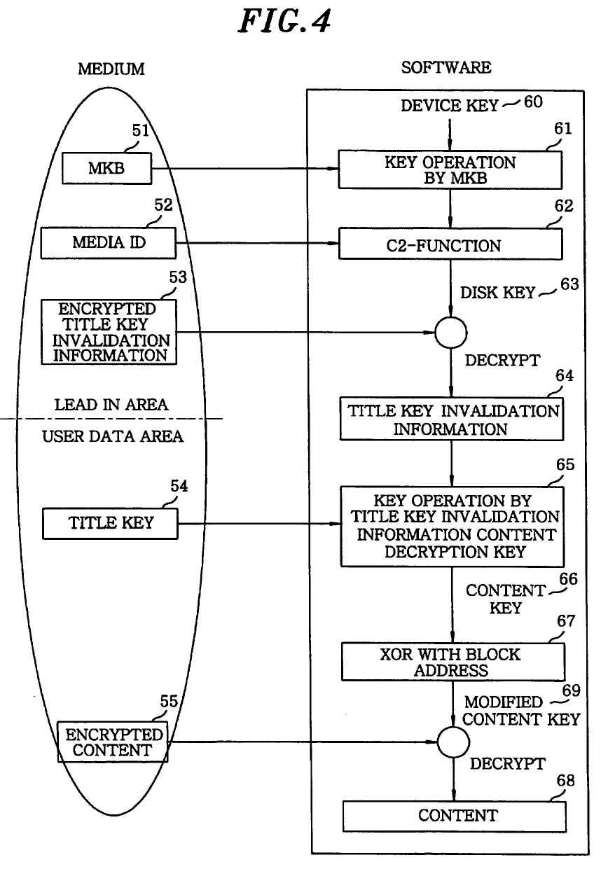

Here, if the medium is unused or empty, i.e. when a content is recorded in a new medium, title key invalidation information is newly generated. Next, in case of reproducing content, as shown in FIG. 4, disk key 63 for encrypted title key invalidation information 53 is obtained (C2-function 62) from media ID 52 and the result of key-operation 61 on device key 60 by MKB 51. Then, disk key 63 is decrypted by encrypted title key invalidation information 53 to thereby obtain title key invalidation information 64. By key-operation 65 on title key invalidation information 64 and title key 54, content key 66 for decrypting an encrypted content is obtained. Software 23 decrypts the encrypted content 55 by using modified content key 69 generated by the exclusive-OR operation on content key 66 and a block address of the content data, decodes the decrypted content, and display the result to thereby reproduce the content.

Hereinafter, the case of moving content will be described. First of all, when moving a content, invalidation process of a title key corresponding to the original content is executed by modifying the title key invalidation information. The invalidation method will not be described in detail since various methods can be adopted, e.g. a method for invalidating a device key by MKB as described in Japanese Patent Laid-open Application No. 2000-31922, or an invalidation method by a tree architecture as described in RFC(Request For Comment) 2627. The title key invalidation information changed for invalidating the title key is encrypted by disk key 63 and transmitted to the drive. The drive writes the encrypted title key invalidation information in a specific area outside the user area of the original medium. That is, the newly generated encrypted title key invalidation information is overwritten on the old one 53.

After invalidating the title key, encrypted content 55 in the original medium is decrypted by modified content key 69 previously obtained by the content reproducing method shown in FIG. 4 and stored in a temporary area of the software. Then, the content is encrypted according to a format of a transfer location for copyright protection, and stored in a transfer medium(i.e. a medium to which the content is moved). That is, decrypted content 68 obtained as described above is encrypted by a newly modified content key generated by content key 66 and a block address of the content data in the transfer medium. Then, the encrypted content and title key 54 transferred from the original medium are recorded in the user area of the transfer medium. Title key invalidation information 64 of the original medium previously obtained by the reproduction method shown in FIG. 4 is encrypted by a new disk key of the transfer medium and stored in an area outside the user area of the transfer medium.

### Second Preferred Embodiment

The description of FIG. 1, and the authentication process between the drive and the software and the content reproduction method of first preferred embodiment are equally applied in the present embodiment.

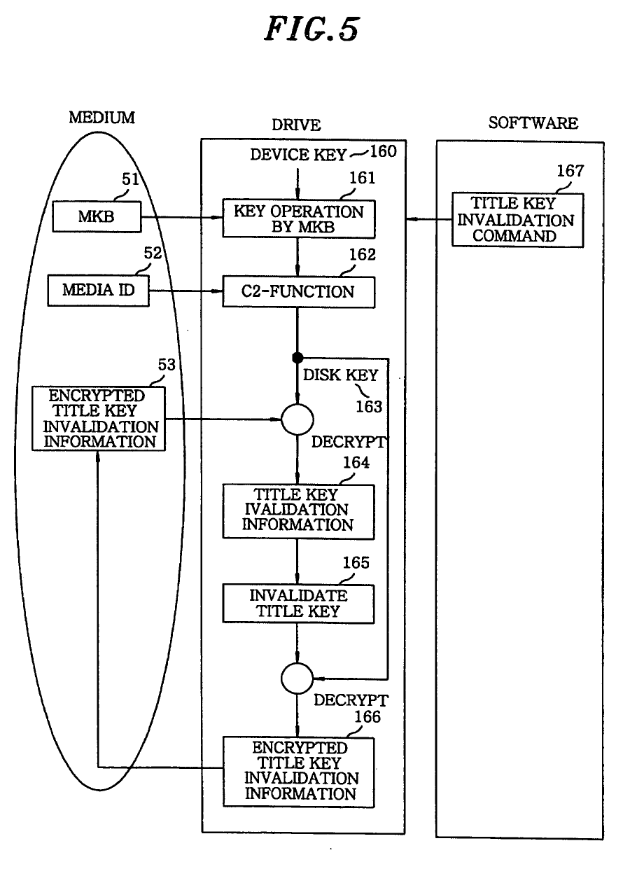

In case of moving content, as shown in FIG. 5, software 23 generates title key invalidation command 167 for a specific title to drive 20. Drive 20 receiving title key invalidation command 167 carries out invalidation process 165 on the specific title key corresponding to title key invalidation information 164 decrypted by using disk key 163. The title key invalidation information processed to invalidate the specific title key is encrypted by disk key 163 and-the encrypted title key invalidation information 166 is written in a specific area outside the user area of the original medium.

After invalidating the title key, encrypted content 55 in the original medium is decrypted by modified content key 69 previously obtained by the content reproduction method shown in FIG. 4 and stored in a temporary area of the software. Then, the content is encrypted according to a format of a transfer location for copyright protection, and stored in a transfer medium. That is, decrypted content 68 is encrypted by a new content key generated by content key 66 and a block address of the content data in the transfer medium. Then, the encrypted content and title key 54 transferred from the original medium are recorded in the user area of the transfer medium. Title key invalidation information 64 of the original medium previously obtained by the reproduction method shown in FIG. 4 is encrypted by new disk key of the transfer medium and stored in an area outside the user area of the transfer medium.

### Third Preferred Embodiment

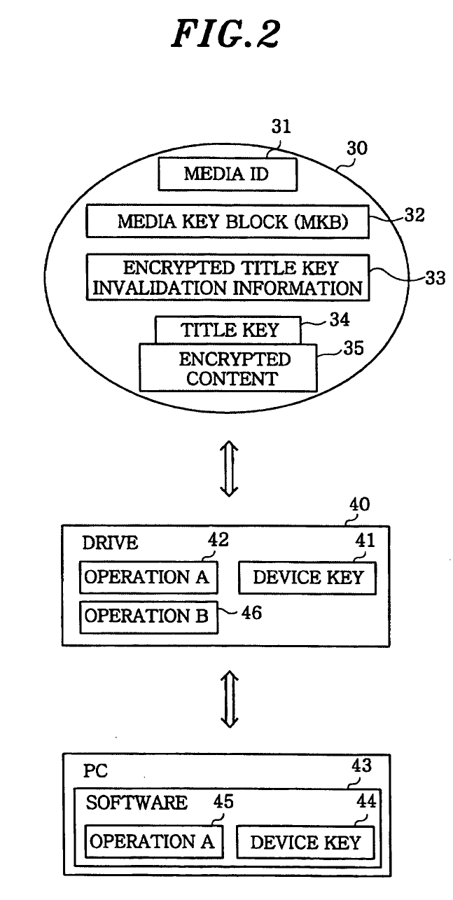

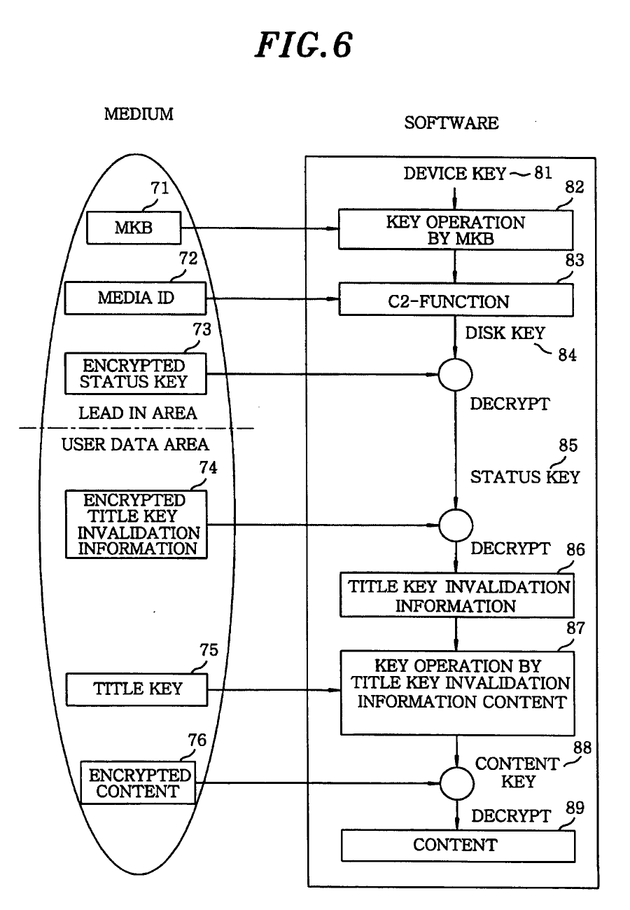

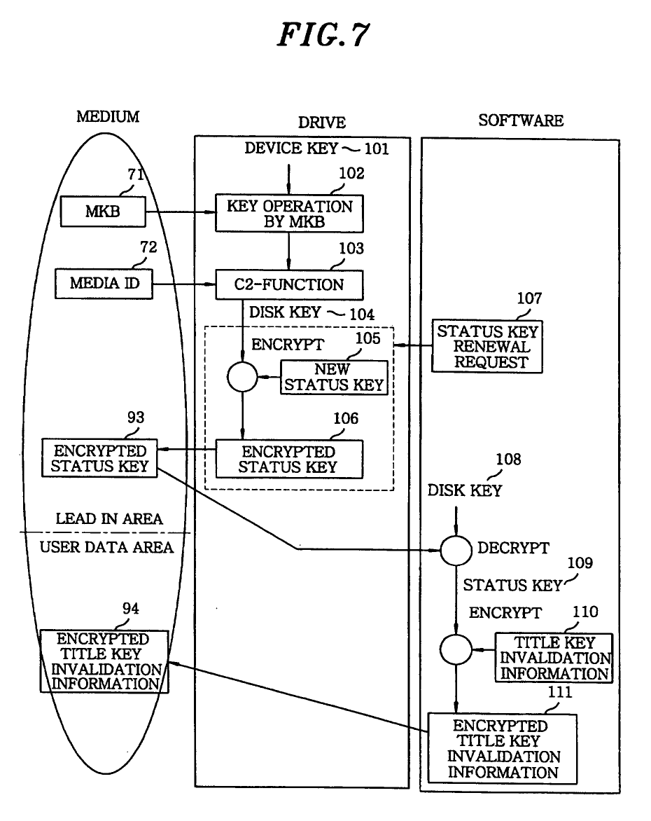

Referring to FIG. 2, media ID 31 uniquely assigned to every medium and media key block(MKB) 32 serving as device key invalidation information are written in advance in an area outside the user area as overwriting disabled information. Encrypted status key 36, which correspond to encrypted status keys 73 and 93 in FIGS. 6 and 7, is also stored outside the user area. Encrypted title key invalidation information 33 is stored in a writable area inside the user area and title key 34 corresponding to stored encrypted content 35 is stored as content management information. Drive 40 has device key 41 and a content reproduction device, e.g. software 43 in a personal computer (PC), also has device key 44. Operation blocks 40, 45 and 46 correspond to those 22, 25 and 26 in FIG. 1.

First, software 43 and drive 40 performs authentication by exchanging keys. The authentication process of the present embodiment is identical to that of the first preferred embodiment. Next, as shown in FIG. 6, disk key 84 for decrypting encrypted status key 73 is obtained by C2-function 83 from media ID 72 and the result of key-operation 82 on device key 81 by MKB 71. Then, encrypted status key 73 is decrypted by disk key 84 to generate status key 85. Encrypted title key invalidation information 74 is decrypted by status key 85 to thereby obtain title key invalidation information 86. By key-operation 87 on title key invalidation information 86 and title key 75, content key 88 for decrypting an encrypted content is obtained. Software 43 decrypts encrypted content 76 by using content key 88, decodes the decrypted content, and display the result to thereby reproduce the content.

Hereinafter, the case of moving content will be described. First of all, when content moving, invalidation process of a title key corresponding to the original content is executed by modifying the title key invalidation information, thereby generating new title key invalidation information. The method for invalidating the title key of the present embodiment is identical to that of the first preferred embodiment. Next, software 43 generates status key renewal request 107 to renew status key 85, to drive 40, as shown in FIG. 7. Drive 40 generates new status key 105 by using random numbers for example, and encrypts same using disk key 104 previously obtained in a manner as in the content reproduction method in FIG. 6. Newly encrypted status key 106 is overwritten on encrypted status key 73 and stored in an area outside the user area on the original medium as new encrypted status key 93. Then, software 43 takes encrypted status key 93 and encrypts invalidated title key invalidation information 110 using status key 109 obtained by decrypting encrypted status key 93 by disk key 108. Encrypted title key invalidation information 111 is stored in a user area as title key invalidation information 94.

After invalidating the title key as described above, the encrypted content in the original medium is decrypted by content key 88 previously obtained by using the content reproduction method shown in FIG. 6 and stored in a temporary area of the software. Then, the content is encrypted according to a format of a transfer location for copyright protection, and stored in a transfer medium. That is, the decrypted content is encrypted by the content key generated by a new title key in the transfer medium and title key invalidation information 86 of the original medium. Then, the encrypted content and the new title key are recorded in the user area of the transfer medium together. Title key invalidation information 86 of the original medium obtained by the content reproduction method shown in FIG. 6 is encrypted by the status key 85 of the original medium and stored in the user area of the transfer medium. Status key 85 is encrypted by the new disk key of the transfer medium, and the encrypted status key is recorded in an area outside the user area of the transfer medium.

In accordance with the present invention, since the title key invalidation information in the original medium is changed to invalidate the title key of the moved content, the content cannot be reproduced although the content is copied back onto the original medium. However, in the transfer medium to which the content is moved, the original title key invalidation information not changed is encrypted by a new disk key of the transfer medium. Accordingly, the present invention can prevent the content from being replicated while enabling the content to be reproduced in the transfer medium. Further, the modified content key for decrypting the content is generated by the block address of the content data and the content key obtained by the title key and the title key invalidation information. Therefore, when content is copied into another area within an identical medium, the copied content cannot be reproduced since the block address is different. As a result, replication of contents within a medium can be prevented.

Though the third preferred embodiment has been described to generate the content key to encrypt and decrypt content without using the block address of the content data, it is preferable to encrypt and decrypt the content by using the modified content key obtained by the content key and the block address, as in the first and the second preferred embodiment.

Further, although the third preferred embodiment has been described to use the new title key to generate the content key when the content is stored in the transfer medium, it is also possible to generate the content key by using the title key of the original medium.

The preferred embodiments have been described with reference to a case of drive and software connected to personal computer. However, the present invention can be equally applied to a use that the drive and the software are integrated in a record device. Further, the storage area outside the user area, which stores the title key invalidation information or the status key, can be prepared in a wireless communication IC chip embedded in a disk to give similar effects.

The preferred embodiments of the present invention can be equally applied when removing or adding a content from and in a medium.

While the invention has been shown and described with respect to the preferred embodiment, it will be understood by those skilled in the art that various changes and modifications may be made without departing from the spirit and scope of the invention as defined in the following claims.

What is claimed is:

1. A content protection method comprising the steps of:
generating a title key invalidation information for invalidating a title key corresponding to a content in a medium;
generating a content key from the title key and the title key invalidation information;
encrypting the content based on the content key;
changing the title key invalidation information in case of removing or moving the content from the medium; and
storing the changed title key invalidation information in the medium.

2. The method of claim 1, wherein the changed title key invalidation information is stored in an area outside a user area.

3. The method of claim 1, wherein the encrypting step includes the steps of:
generating a modified content key from the content key and an address indicating a storage position of the content in the medium; and
encrypting the content by using the modified content key.

4. The method of claim 1, wherein the changing step includes the steps of:
generating a status key having a value changed by moving, removing or adding a content;
encrypting the title key invalidation information by using the status key; and
storing the status key in an area outside a user area,
wherein, the title key invalidation information is stored in the user area to which common reading or recording devices are able to access.

5. An information recording and reproduction apparatus comprising:
a first generating unit for generating a title key invalidation information for invalidating a title key corresponding to a content in a medium;
a second generating unit for generating a content key from the title key and the title key invalidation information;
a first encrypting unit for encrypting the content based on the content key;
a changing unit for changing the title key invalidation information in case of removing or moving the content from the medium; and
a first storing unit for storing the changed title key invalidation information in the medium.

6. The apparatus of claim 5, wherein the changed title key invalidation information is stored in an area outside a user area.

7. The apparatus of claim 5, wherein the encrypting unit includes:
a third generating unit for generating a modified content key from the content key and an address indicating a storage position of the content in the medium; and
a second encrypting unit for encrypting the content by using the modified content key.

8. The apparatus of claim 5, wherein the changing unit includes:
a fourth generating unit for generating a status key having a value changed by moving, removing or adding a content;
a third encrypting unit for encrypting the title key invalidation information by using the status key; and
a second storing unit for storing the status key in an area outside a user area,
wherein, the title key invalidation information is stored in the user area to which common reading or recording devices are able to access.
